(19) United States
(12) Patent Application Publication
(10) Pub. No.: US 2023/0032782 A1
(43) Pub. Date: Feb. 2, 2023

(54) Self-Sovereign Identity Verifiable Credentials for Consent Processing

(71) Applicant: NCR Corporation, Atlanta, GA (US)

(72) Inventors: Bryan Walser Nonni, Atlanta, GA (US); Alexander Simon Lewin, Atlanta, GA (US)

(21) Appl. No.: 17/966,422

(22) Filed: Oct. 14, 2022

Related U.S. Application Data
(62) Division of application No. 17/162,663, filed on Jan. 29, 2021.

(51) Int. Cl. G06Q 30/02; G06Q 20/40

(52) U.S. Cl. CPC G06Q 30/0201; G06Q 20/401

(57) ABSTRACT

A consumer obtains a consent credential for a given retailer. The consent credential identifies receipt data, which the consumer is authorizing the retailer to obtain. A consumer engages in a wallet-to-wallet transaction with a retailer utilizing Decentralized Identifiers (DIDs) for the wallets of the consumer and the retailer. Receipt data is produced by a payment service on behalf of the retailer, the receipt data is signed by an issuing authority associated with the retailer and delivered as a receipt credential to the consumer. The receipt data is not maintained by the payment service nor the retailer. The retailer requests the receipt data after from the consumer after payment is processed for the transaction by the payment service. The consumer authorizes the request or denies the request, when authorized the receipt credential and corresponding authorized portions of the receipt data are provided from the consumer to the retailer.

### CROSS-REFERENCE TO RELATED APPLICATION

This application is a division of U.S. Pat. Application Serial No. 17/162,663, filed Jan. 29, 2021, which application and publication is incorporated herein by reference in its entirety.

### BACKGROUND

Enterprises and governments rely heavily and collecting data from their customers and citizens. In fact, private and public information about every individual is almost certainly maintained by a plethora of different entities in a variety of data warehouse located across the globe. This has caused a great deal of problems for individuals and for the enterprises. Individuals’ personal and private data are routinely stolen and used for nefarious purposes with the unwittingly assistance of government bureaucrats and government systems to obtain false government identification cards or government benefits. Consumers are frequently targeted and harassed by businesses based on their spending habits, browser history, and location data.

In the midst of this chaos, governments are finally realizing that data about an individual should belong to the individual and not collected and used by businesses, governments, or organizations. Some countries have adopted more stringent laws and regulations should a consumer be harmed by a data breach at an enterprise that houses some of the consumer’s data. Some countries have adopted laws that make clear any retention of consumer data needs to have the express informed consent of the consumer and/or requires payment of a fee to the consumer.

Even without this slow movement of the governments towards protection of the consumer, consumers are fighting back filing lawsuits against businesses where data breaches expose their data. Liability insurance for businesses is significantly on the rise. The expense associated with security systems is also on the rise. Moreover, businesses realize that consumers are becoming more conscious of the character of the businesses with which they do business and how that character aligns with the consumer’s personal beliefs and causes.

In short, a variety of factors are slowing forcing enterprises to acknowledge that their old data model where the enterprise stores and controls consumer data is rapidly becoming obsolete and a new data model is emerging where the consumer data is owned and controlled by the consumer. Most enterprises are not prepared for this transition and their business models and business systems continue to rely heavily on the old data model.

### SUMMARY

In various embodiments, methods and a system for self-sovereign identity (SSI) verifiable credentials for consumer consent processing are presented.

According to an embodiment, a method for SSI verifiable credentials for consumer consent processing is provided. Specifically, and in one embodiment, a retailer-specific data consent request is received from a consumer that identifies a retailer. Selections from the consumer are obtained, each selection comprises a field description associated with a field of receipt data and an indication as to whether the consumer authorizes or does not authorize the retailer to view the corresponding field of the receipt data. A consent data structure is generated comprising the fields, the indications, and a schema that defines the fields. The consent data structure is delivered to an issuing authority for a signature of the issuing authority on the consent data structure, which causes a signed-consent data to be delivered to the consumer as consent credential.

### BRIEF DESCRIPTION OF THE DRAWINGS

FIG. 1 is a diagram of a system for SSI verifiable credentials for consumer consent processing, according to an example embodiment.

FIG. 2 is a diagram of a method SSI verifiable credentials for consumer consent processing, according to an example embodiment.

FIG. 3 is a diagram of another method SSI verifiable credentials for consumer consent processing, according to an example embodiment.

### DETAILED DESCRIPTION

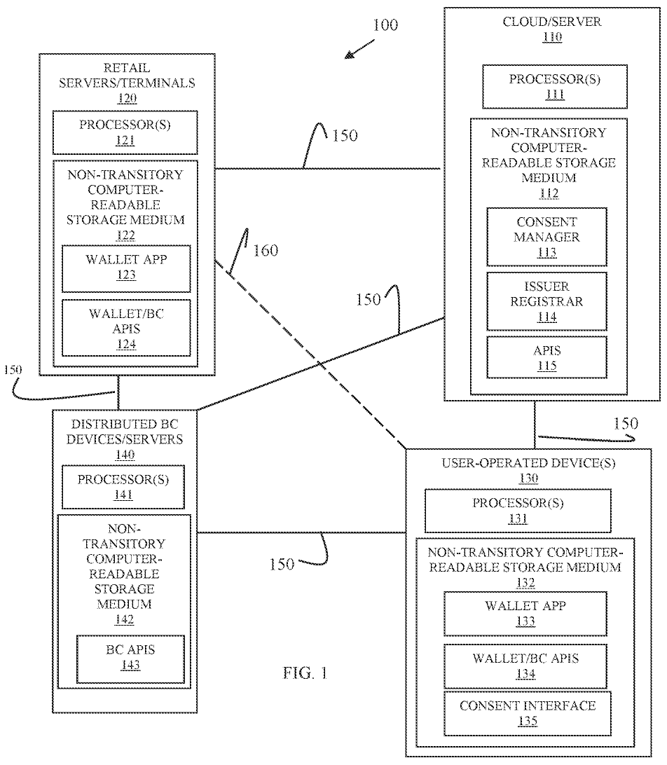

FIG. 1 is a diagram of a system 100 for SSI verifiable credentials for consumer consent processing, according to an example embodiment. The system 100 is shown schematically in greatly simplified form, with only those components relevant to understanding of one or more embodiments (represented herein) being illustrated. The various components are illustrated, and the arrangement of the components is presented for purposes of illustration only. It is to be noted that other arrangements with more or less components are possible without departing from the SSI verifiable credentials for consumer consent processing presented herein and below.

Moreover, various components are implemented as one or more software modules, which reside in non-transitory storage and/or hardware memory as executable instructions that when executed by one or more hardware processors perform the processing discussed herein and below.

System 100 provides verifiable techniques by which a consumer can give express and informed consent to a consumer-identified retailer for access to the consumer’s transaction receipt data following a purchase made by the consumer. The verification is based on a verifiable consent credential for the consumer that expressly authorizes or does not authorize specific granular components or fields of that receipt data (transaction data) that can be received by the specific retailer. Additionally, each individual consumer transaction comprises a transaction credential of the retailer. Assuming the credentials are verified, and a transaction is processed, only the authorized fields/components of the receipt data are shared with the authorized retailer for any given transaction.

Further, the techniques provided by system 100 are verifiable through uses of distributed blockchain processes and public-private key digital signature verification. When authorization is provided, the corresponding authorized fields of the receipt data are provided to the authorized retailer. This approach allows retailers to unobtrusively obtain consumer authorization to receipt data and provides an irrefutable audit trail that the retailers can rely on. The techniques provide the consumer complete control over the consumer’s receipt data and the techniques provide retailers with an irrefutable audit trail evidencing authorized access to the consumer’s receipt data. Furthermore, the techniques are processed in a decentralized manner with nearly impenetrable security and compliance evidence that accounts for nearly any foreseeably imposed governmental restriction.

The system 100 includes: a cloud/server 110, retail servers/terminals 120, a plurality of user-operated devices 130, and a plurality of blockchain (BC) devices/servers 140.

Cloud/server 110 comprises one or more hardware processors 111 and a non-transitory computer-readable storage medium 112. Medium 112 comprises executable instructions for a consent manager 113, optionally, issuer registrar 114, and APIs 115. When the executable instructions are provided to processor 111, this causes processor 111 to perform operations discussed herein and below for consent manager 113.

Each retail server/terminal 120 comprises one or more processors 121 and a non-transitory computer-readable storage medium 122. Medium 122 comprises executable instructions for a wallet application (app) 123 and wallet/BC Application Programming Interfaces (APIs). When the executable instructions are provided to processor 121, this causes processor 121 to perform operations discussed herein and below for wallet app 123 and wallet/BC APIs 124.

Each user-operated device 130 comprises one or more processors 131 and a non-transitory computer readable storage medium 132. Medium 132 comprises executable instructions for a wallet application (app) 133, walletlBC APls 134, and consent interface 135. When the executable instructions are provided to processor 131, this causes processor 131 to perform operations discussed herein and below for wallet app 133, wallet/BC APIs 134, and consent interface 135.

Distributed BC devices/servers comprises processors 141 and a non-transitory computer readable storage medium 142 for each BC device/server 140. Medium 140 comprises executable instructions for BC APIs 143. When the executable instructions are provided to corresponding processor 141, this causes processor 141 to perform operations discussed herein and below for BC APIs 143.

Various network connections 150 and 160 are discussed herein and below between the devices 110-150. Some connections 150 are established directly between devices while other connections 160 are achieved using Decentralized Identifiers (DIDs). DID-based connections 160 providing an anonymous communication session between servers/terminals 120 and user-operated devices 130 based on addressing scheme associated with SSIs; the addresses are resolved through the BC APIs 143. Moreover, although not shown in FIG. 1, during the processing discussed herein and below, there may be DID-based connections 160 between cloud/server 110 and user-operated device 130 and between retail servers/terminals 120 and cloud/server 110. Still further, although connections 150 are discussed as direct connections between distributed BC devices/servers 140 to 110-113, it is directed only in the sense of the first node/server 140 that is interacting with 110-113.

In various discusses the phrase “issuing authority” or “issuer” are used these may be located on standalone servers, located on server 110, located on a server 120, or located over blockchain devices/servers 150. Any configuration may be used when referencing an issuing authority or an issuer herein and below.

Initially, a consumer operating device 130 registers via consent interface 135 with consent manager 113 for purposes of authorizing specific retailers with access to their transaction or receipt data for transactions of the consumer. Consent interface 135 presents the consumer with a listing of retailers/merchants for which the consumer can connect to or authorize for receiving receipt data of the consumer. Issuer registrar 114 provides the listings of available retailers to consent manager 113. These may be merchants that have signed on to the SSI verifiable credential service offered by cloud/server 110, have provided a DID wallet address for communicating with wallet APP 123, and, optionally, have provided a public key for that retailer’s or that retailer’s wallet issuing authority.

Upon selection of a specific retailer/merchant, consent manager 113 through interface 134 a connection 160 (DID-based anonymous connection) utilizing BC APIs 143 of devices/servers 140 between user-operated device 130 and a selected retailer’s server/terminal 120. Once the consumer is connected over 160 to a merchant, which the consumer desires to share receipt data with, wallet app 133 communicates with wallet app 123 utilizing APIs 134 and 124. Wallet App 123 asks the consumer through a user-facing interface of wallet app 133 whether the consumer desires to share receipt data with the merchant connected to the consumer. This user-interface screen also displays fields or component pieces of the merchant’s typical receipt data, such as name field, loyalty number field, item code, item description, date, time, store identifier, price paid, any discounts used, selling clerk identifier, terminal identifier, etc. Next to each generic field label in the interface screen is a button or option that is selectable by the consumer to authorize or not authorize (yes - authorize, no- not authorized) that particular field or component of the retailer’s receipt data. The consumer makes the desired selections by selecting yes for authorization on each field that was authorized and no for no authorization (note the “no” selection may be prepopulated in each of the fields by default such that the user only has to affirmatively changes those field selections for which the user is responding “yes” for authorization) .

APIs 134 then assemble the selections for the retailer and generates an SSI credential request comprising a data structure having the consumer’s answer to each filed in the receipt data for that retailer. This SSI credential request is sent by Wallet/BC APIs 134 over distributed BC devices/servers 140 using BC APIs 143 to an SSI issuing authority. The SSI issuing signs the data structure with a private key of the issuer and sends back to consumer using BC APIs 143 where it is received by wallet/BC APIs 134 and stored for access by wallet app 133 as an SSI-retailer consent credential. The SSI-retailer consent credential signed by the SSI authority is controlled and remains with the consumer on the consumer’s device 130.

Next, the consumer performs a transaction with the retailer utilizing a DID-based connection 160. The transaction may be conducted by the user in-person at a brick-and-mortar store or online. The DID for the wallet app 123 of the retailer may be acquired and processed in any number of manners, such as by the consumer scanning a Quick Response (QR) code displayed at a terminal 120 of the retailer or scanning/detecting a QR presented on a payment screen interface screen of the retailer for an online transaction.

Once a DID-based connection 160 is made between wallet 100 123 and wallet app 134, the consumer can pay the retailer for the transaction purchase using any acceptable form of payment that is accepted by the retailer, such as credit card, cash, digital currency, a payment service (e.g., PayPalⓇ, VenmoⓇ, ZelleⓇ, etc.), Accounts Receivable Conversion (ARC), etc. Note that the actual payment processing itself may or may not be over DID-based connections. DID-based connection 160 between the retailer and the consumer does not have to be the connection used by the retailer to obtain the payment funds (although it can be when payment is through a directed wallet to wallet exchange).

The payment service used to obtain the consumer’s payment generates the receipt data for the transaction and provides it along with the DID for the consumer’s wallet to an issuing authority associated with the retailer 120 (note that this may be a component of the retailer’s system or a third-party payment service).

In an embodiment, the payment service is a component of the retailer, such that the retailer can sign the receipt data before the receipt data is passed with the consumer’s DID and signed also by a retailer-designated issuer. In some cases, that designated issuer may reside on cloud/server 110, terminal/server 120, and/or BC devices/servers 140, or may be a standalone server unassociated with 110, 120, and 140.

The retailer’s issuing authority vouches for the receipt data as being authentically produced by the retailer. The receipt data/retailer issuing authority may in some cases be a component of cloud/server 110.

Moreover, a public key of the retailer’s issuing authority may be made available to consumers via the issuer registrar 114, which may comprise a registry of issuing authorities associated with each retailer along with their public keys. A single retailer may have multiple issuers, such that each separate digital wallet (and its instance of wallet app 123) may have its own unique issuer (a retailer may maintain multiple wallets).

The retailer’s issuing authority receives the receipt data and the DID for the consumer’s digital wallet (wallet app 133) and signs the receipt data with a private key of the retailer’s issuing authority (again noted that this may be the retailer, may be cloud/server 110, or may be a third party). The signed receipt data is provided to the consumer via the BC APIs 143 as a transaction-receipt credential.

At this point, the consumer has two credentials in their wallet that lives or resides on device 130, the original SSI-retailer consent credential (established during the initial onboarding process or registration process discussed above and comprising the signature of the SSI authority along with the fields and consents or non-consent selections made by the consumer) and the Transaction-receipt credential (which also has the receipt data generated by the payment service used for the transaction along with a signature of the retailer’s issuing authority).

Note also that there are two authorities, the SSl authority that provides the first credential (signed consents to receipt data by field for a specific retailer) as the SSI-retailer consent credential to the consumer and the retailer’s issuing authority that provides the signed receipt data on behalf of the retailer as the Transaction-receipt credential. Furthermore, both authorities may be associated with the retailer, independent of the retailer, and/or part of cloud/server 110.

Once the payment service confirms the transaction was paid for by the consumer, wallet app 123 using APIs 124 makes a Proof Request to the consumer’s wallet app over 160. This Proof Request will include a request by field for the raw data associated with the receipt data. This causes wallet app 133 to present a pop-up interface screen on the display of device 130 asking the consumer whether the consumer wants to share the receipt data with the retailer along with the field selections made by the retailer in the Proof Request and the selections for those fields that the user initially made in the initial SSI-retailer credential. The user can permit those previous field selections to be given to the retailer through options presented in the pop-up screen, override previous authorized fields to not be authorized for the transaction, provided new authorizations for fields previous unauthorized, or deny the request entirely.

If the user denies the request, then nothing further transpires, and the Proof Request is denied. In this case, the retailer never gets any of the receipt data and the consumer maintains control over all fields of the receipt data. Moreover, the receipt data only lives on the consumer’s device 130. The payment service and the retailer’s issuing authority do not retain any copies of the receipt data that they possessed at one point (actually generated by the payment service). The receipt data is completely removed from storage and never maintained by the payment service or the retailer’s issuing authority.

Selections authorized by the user in responding to the Proof Request cause APIs 135 to deliver the transaction-receipt credential of the retailer along with the raw data associated with the fields authorized by the consumer back to the retailer over DID-based connection 160.

The retailer can prove that the retailer was authorized to receive the raw data associated with those fields by verifying the signature of the retailer’s issuing authority using a public key of the retailer’s issuing authority and/or a public key of the retailer in cases where the retailer also signed the transaction-receipt credential.

The consumer can verify that the receipt data originated with the retailer by obtaining the retailer’s issuing authority’s public key from issuer registrar 114. In some cases when the retailer also signed the receipt data, the consumer uses a public key of the retailer to verify that the retailer also has a valid signature on the receipt data.

In an embodiment, the APIs 124, 134, and 143 provide additional operations associated with revoking and invalidating a previously issued SSI-retailer credential and/or modify and replace a previously issued SSI-retailer credential. In this way, the consumer maintains control, and should data sharing become problematic for the consumer, the consumer can revoke authorizations going forward.

APIs 115 of cloud/server 110 may be used to perform and of the interactions discussed herein and above with respect to cloud/server 110.

In an embodiment, APIs 124, 134, and 143 provide additional operations to reproduce an audit trail of a given transaction between two or more DID wallets for verification that delivery of the receipt data was made to the consumer and was signed by the retailer’s issuing authority, the Proof Request was sent to the consumer, and the delivery of the raw receipt data and SSI-retailer credential back to the retailer. That is, APls 143 maintain a distributed-based and retrieval audit log for any DID-based connections 160. This ensures that the actual actions taken during a given DID-based connection 160 cannot be forged, are irrefutable, and are reproducible. This provides the consumer complete control over the consumer’s data in a secure and verifiable manner and provides the retailer with evidence when consent was given so that liability of the retailer for uses of consumer’s data is eliminated. It satisfies the needs and desires of both the consumer and the retailer.

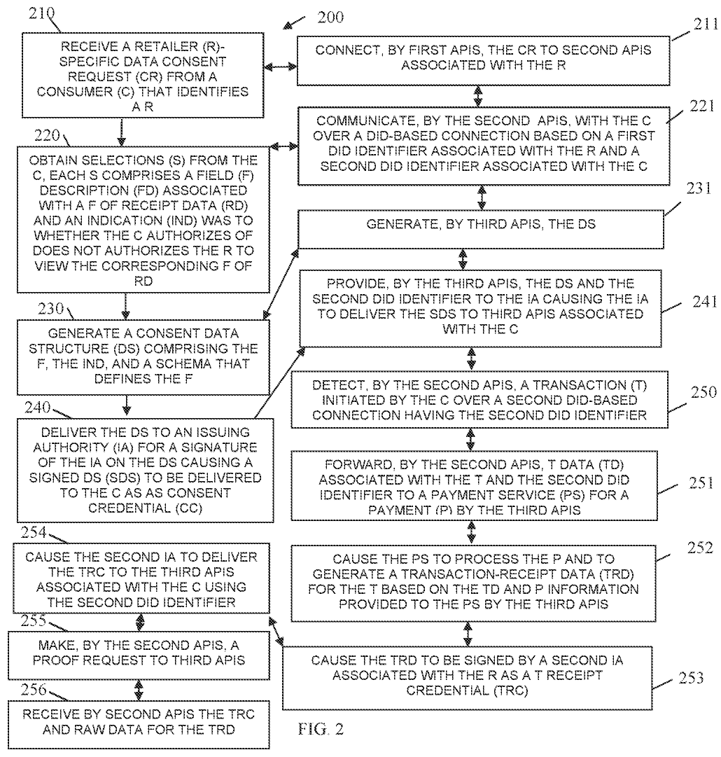

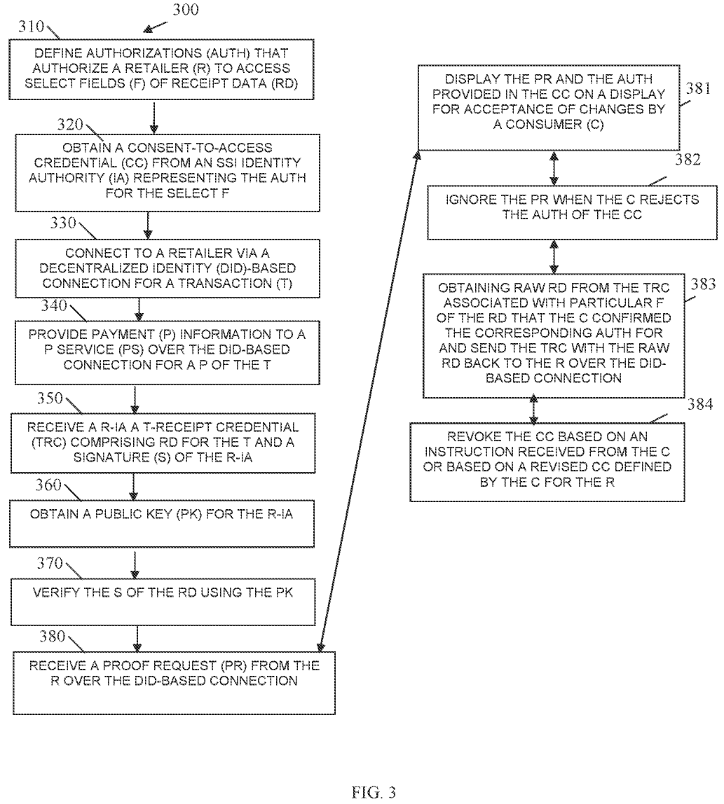

The embodiments of FIG. 1 and other embodiments are now discussed with reference to the FIGS. 2-3.

FIG. 2 is a diagram of a method 200 for SSI verifiable credentials for consumer consent processing, according to an example embodiment. The software module(s) that implements the method 200 is referred to as a “data consent manager.” The data consent manager is implemented as executable instructions programmed and residing within memory and/or a non-transitory computer-readable (processor-readable) storage medium and executed by a plurality of hardware processors of a plurality of hardware computing devices. The processors of the devices that execute the data consent manager are specifically configured and programmed to process the data consent manager. The data consent manager has access to one or more networks during its processing. The networks can be wired, wireless, or a combination of wired and wireless.

In an embodiment, the devices that execute the data consent manager is cloud/server 110, server 120, user-operated device 130, and/or servers 140. In an embodiment, a plurality of servers cooperate to execute the data consent manager from one or more logical cloud servers 110, 120, 130, and/or 140.

In an embodiment, the data consent manager is all or some combination of 113, 114, 115, 123, 124, and/or 134, discussed above with system 100.

At 210, the data consent manager receives a retailer-specific data consent request from a consumer that identifies a retailer.

In an embodiment, at 211, connecting, by first APIs 115 associated with cloud/server 110, the retailer-specific data consent request to second APIs 124 associated with the retailer.

At 220, the data consent manager obtains selections from the consumer. Each selection comprises a field description associated with a field of receipt data and an indication as to whether the consumer authorizes or does not authorize the retailer to view of have access to the corresponding field of the receipt data.

In an embodiment of 211 and 220, at 221, the data consent manager causes, by the second APIs 124, a DID-based connection based on a first DID identifier associated with the retailer and a second DID identifier associated with the consumer.

At 230, the data consent manager generates a consent data structure comprising the fields, the indications, and a schema that defines the fields.

In an embodiment of 221 and 230, at 231, the data consent manager generating, by third APIs 134, the consent data structure.

At 240, the data consent manager delivers the consent data structure to an issuing authority for a signature of the issuing authority on the consent data structure to be delivered to the consumer as a consent credential.

In an embodiment of 231 and 240, at 241, the data consent manager provides, by the third APIs 134, the consent data structure and the second DID identifier to the issuing authority causing the issuing authority to deliver the signed-consent data structure (consent credential) to third APIs 134 associated with the consumer.

In an embodiment of 241 and at 250, the data consent manager detects, by the second APIs 124, a transaction initiated by the consumer over a second DID-based connection having the second DID identifier associated with the consumer.

In an embodiment of 250 and at 251, the data consent manager forwards, by the second APIs 124, transaction data associated with the transaction and the second DID identifier to a payment service for a payment of the transaction.

In an embodiment of 251 and at 252, the data consent manager causes the payment service to process the payment and to generated transaction receipt data for the transaction based on the transaction data and payment information provided to the payment service by the third APIs 134 associated with the consumer.

In an embodiment of 252 and at 253, the data consent manager causes the transaction receipt data to be signed by a second issuing authority associated with the retailer as a transaction-receipt credential.

In an embodiment of 253 and at 254, the data consent manager causes the second issuing authority to deliver the transaction-receipt credential to the third APIs 134 associated with the consumer using the second DID identifier.

In an embodiment of 254 and at 255, the data consent manager makes, by the second APIs 124, a Proof Request to the third APls. The Proof Request comprises retailer requests for select fields of the transaction receipt data that is made to the consumer via the third APIs 134.

In an embodiment of 255 and at 256, the data consent manager receives, by the second APIs 124 via the third APIs 134, the consent credential (signed-consent data structure) and raw data associated with the select fields of the transaction receipt data when authorized by the consumer.

FIG. 3 is a diagram of another method 300 for SSI verifiable credentials for consumer consent processing, according to an example embodiment. The software module(s) that implements the method 300 is referred to as a “blockchain-based data consent manager.” The blockchain-based data consent manager is implemented as executable instructions programmed and residing within memory and/or a non-transitory computer-readable (processor-readable) storage medium and executed by one or more hardware processors of one or more hardware devices. The processors of the devices that execute the blockchain-based data consent manager are specifically configured and programmed to process the blockchain-based data consent manager. The blockchain-based data consent manager has access to one or more networks during its processing. The networks can be wired, wireless, or a combination of wired and wireless.

The blockchain-based data consent manager presents another and, in some ways, enhanced processing perspective of that which was described above with the method 200. That is, method 200 discussed the processing of cloud/server 120 as the first APIs 115, processing of terminal/server 120 as second APls 124, and some processing of user-operated device 130 as third APIs 134. The blockchain-based data consent manager presents the processing operations of the user-operated device’s API 134.

In an embodiment, device 120 executes the blockchain-based data consent manager.

In an embodiment, the blockchain-based data consent manager is all or some combination of 133-135, and/or some portions of method 200.

At 310, the blockchain-based data consent manager defines authorizations that authorize a retailer to access select fields of receipt data.

At 320, the blockchain-based data consent manager obtains a consent-to-access credential from an SSI authority representing the authorizations for the select fields and signed with a private key of the SS I authority.

At 330, the blockchain-based data consent manager connects to a retailer via a DID-based connection for a transaction between a consumer and the retailer.

At 340, the blockchain-based data consent manager provides payment information to a payment service over the DID-based connection for a payment of the transaction.

At 350, the blockchain-based data consent manager receives from a retailor-issuing authority a transaction-receipt credential comprising receipt data for the transaction and a signature of the retailer-issuing authority.

At 360, the blockchain-based data consent manager obtains a public key for the retailer-issuing authority. This may be issuer registrar 114 of cloud/server 110.

At 370, the blockchain-based data consent manager verifies a signature of the receipt data using the public key.

In an embodiment, at 380, the blockchain-based data consent manager receives a Proof Request from the retailer over the DID-based connection.

In an embodiment of 380 and at 381, the blockchain-based data consent manager displays the Proof Request and the authorizations provided in the consent-to-access credential on a display for acceptance or changes by the consumer.

In an embodiment of 381 and at 382, the blockchain-based data consent manager ignores the Proof Request when the consumer rejects the authorizations of the consent-to-access credential and requests associated with the field the retailer requested access to in the Proof Request.

In an embodiment of 382 and at 383, the blockchain-based data consent manager obtains raw receipt data for the transaction-receipt credential associated with particular fields of the receipt data that the consumer confirmed the corresponding authorizations for and the blockchain-based data consent manager sends the transaction receipt credential with the raw data back to the retailer over the DID-based connection.

In an embodiment of 383 and at 384, the blockchain-based data consent manager revokes the consent-to-access credential based on an instruction received from the consumer or based on a revised consent-to-access credential defined by the consumer and issued by the SSI authority.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
defining, by a processor, authorizations that authorize a retailer to access select fields of receipt data;
obtaining, by the processor, a consent-to-access credential from a Self-Sovereign Identity (SSI) authority representing the authorizations for the select fields;
connecting, by the processor, to a retailer via a Decentralized Identity (DID)-based connection for a transaction;
providing, by the processor, payment information to a payment service over the DID-based connection for a payment of the transaction;
receiving, by the processor, from a retailer-issuing authority a transaction-receipt credential comprising receipt data for the transaction and a signature of the retailer-issuing authority;
obtaining, by the processor, a public key for the retailer-issuing authority; and
verifying, by the processor, the signature of the receipt data using the public key.

2. The method of claim 1 further comprising, by the processor, receiving a Proof Request from the retailer over the DID-based connection.

3. The method of claim 2, wherein receiving the Proof Request further includes displaying the Proof Request and the authorizations provided in the consent-to-access credential on a display for acceptance or changes by a consumer.

4. The method of claim 3, wherein displaying further includes ignoring the Proof Request when the consumer rejects the authorizations of the consent-to-access credential.

5. The method of claim 4, wherein displaying further includes obtaining raw receipt data from the transaction-receipt credential associated with particular fields of the receipt data that the consumer confirmed the corresponding authorizations for and sending the transaction receipt credential with the raw receipt data back to the retailer over the DID-based connection.

6. The method of claim 5 further comprising, revoking the consent-to-access credential based on an instruction received from the consumer or based on a revised consent-to-access credential defined by the consumer for the retailer.

7. A system comprising:
a plurality of servers comprising a plurality of processors, each server comprises a non-transitory computer-readable storage media;
each non-transitory computer-readable storage medium comprising executable instructions for first Application Programming Interfaces (APIs) or second APIs;
the first APIs and the second APIs when executed by their corresponding processors performing operations comprising:
defining, by the first APIs and the second APIs, a consent-to-access credential defined by a consumer, wherein the consent-to-access credential comprising authorizations for selects fields of receipt data for a retailer and fields of the receipt data including the select fields comprise a first signature of a Self-Sovereign Identity (SSI) issuing authority to attest to the authenticity of the consent-to-access credential, wherein the consent-to access credential further comprising a schema for the fields of the receipt data;
maintaining the consent-to-access credential by the second APIs associated with a consumer-operated device of the consumer;
establishing by the second APIs a Decentralized Identity (DID)- based connection with the first APIs associated with a retailer-operated device of the retailer;
interacting by the second APIs with a payment service of the retailer to provide a payment for a transaction between the consumer and the retailer;
receiving by the second APIs transaction-receipt data for the payment from a retailer-issuing authority wherein the transaction-receipt data comprising a second signature of the retailer-issuing authority and is provided as a transaction-receipt credential;
obtaining by the second APIs a Proof Request from the first APIs over the DID-based connection;
presenting by the second APIs the Proof Request and the authorizations associated with the consent-to-access credential to the consumer for confirmation or rejection of each field associated with the transaction-receipt credential using the schema;
when at least one confirmation is provided by the consumer, sending by the second APIs the transaction receipt credential and raw data associated with confirmed fields of the transaction receipt data to the first APIs of the retailer.

8. The system of claim 7, wherein the first APIs are associated with a first DID identifier for a first digital wallet of the retailer, wherein the second APIs are associated with a second DID identifier for a second digital wallet of the consumer, and wherein the DID-based connection is processed as a blockchain to allow a wallet-to-wallet connection between the consumer-operated device and the retailer-operated device.

9. A method, comprising:
registering, by a processor, a retailer to receive consumer-designated portions of receipt data produced during transactions by a consumer with the retailer;
obtaining, by the processor, a consent-to-access credential from a first authority;
providing, by the processor, the consent-to-access credential to a consumer device operated by the consumer;
facilitating, by the processor, an anonymous payment for a given transaction between the consumer and the retailer;
providing, by the processor, authenticated receipt data for the given transaction and a transaction credential for the given transaction to the consumer;
receiving, by the processor, authorizations for certain consumer-designated portions of the authenticated receipt data for delivery to the retailer; and
facilitating, by the processor, delivery of the certain consumer-designated portions of the authenticated receipt data to the retailer based on the authorizations.

10. The method of claim 9, wherein facilitating the anonymous payment further includes connecting the retailer to a Decentralized Identity (DID) connection for receiving the anonymous payment from the consumer through a payment service.

11. The method of claim 10, wherein connecting further includes obtaining payment information from the consumer and providing the payment information over the DID connection to the payment service.

12. The method of claim 11, wherein facilitating the anonymous payment further includes receiving a proof request from the retailer over the DID connection.

13. The method of claim 12, wherein receiving further includes presenting fields of the authenticated receipt to the consumer on the consumer device and receiving each authorization for each certain consumer-designated portion that corresponds to a certain field along with the transaction credential.

14. The method of claim 13, wherein facilitating further includes providing raw receipt data associated with the certain consumer-designated portions of the authenticated receipt and the transaction credential to the retailer over the DID connection.

15. The method of claim 9 further comprising, modifying the consumer-designated portions based on a revised consent-to-access credential defined by the consumer for the retailer.

16. The method of claim 9 further comprising, revoking the consent-to-access credential based on an instruction received from the consumer from the consumer device.

17. The method of claim 9 further comprising, interacting with the consumer from a wallet application that processes on the consumer device.

18. The method of claim 9 further comprising, interacting with a retailer system of the retailer through an Application Programming Interface (API).

19. The method of claim 9, wherein providing the authenticated receipt further includes verifying a retailer digital signature on certain receipt data for the given transaction and providing the certain receipt data with the retailer digital signature as the authenticated receipt.

20. The method of claim 9, wherein facilitating delivery of the certain consumer-designated portions for incudes identifying the certain consumer-designated portions as the consumer-designated portions associated with the consent-to-access credential or identifying the certain consumer-designated portions as changes made by the consumer to the consumer-designated portions associated with the consent to access credential.
